(19) United States
(12) Patent Application Publication
(10) Pub. No.: US 2017/0235272 A1
(43) Pub. Date: Aug. 17, 2017

(54) ACCUMULATION REMOVAL DEVICE AND IMAGE FORMING APPARATUS

(71) Applicant: FUJI XEROX CO., LTD., Tokyo (JP)

(72) Inventor: Toshihiko SUZUKI, Kanagawa (JP)

(73) Assignee: FUJI XEROX CO., LTD., Tokyo (JP)

(21) Appl. No.: 15/245,844

(22) Filed: Aug. 24, 2016

(30) Foreign Application Priority Data
Feb. 12, 2016 (JP) 2016-024786

(51) Int. Cl. G03G 21/00

(52) U.S. Cl. CPC G03G 21/0011

(57) ABSTRACT

An accumulation removal device includes a cleaning blade, a fluid supply device, and an instruction device. The cleaning blade is disposed so as to be in contact with a surface of an image holding member and cleans the surface of the image holding member after an image forming process has been performed. The fluid supply device supplies a fluid which contains solid particles to a position where the cleaning blade is disposed. The instruction device issues an instruction to cause the fluid supply device to supply the fluid at predetermined timing.

### CROSS-REFERENCE TO RELATED APPLICATIONS

This application is based on and claims priority under 35 USC 119 from Japanese Patent Application No. 2016-024786 filed Feb. 12, 2016.

### BACKGROUND

### Technical Field

The present invention relates to an accumulation removal device and an image forming apparatus.

### SUMMARY

According to an aspect of the present invention, an accumulation removal device includes a cleaning blade, a fluid supply device, and an instruction device. The cleaning blade is disposed so as to be in contact with a surface of an image holding member and cleans the surface of the image holding member after an image forming process has been performed. The fluid supply device supplies a fluid which contains solid particles to a position where the cleaning blade is disposed. The instruction device issues an instruction to cause the fluid supply device to supply the fluid at predetermined timing.

### BRIEF DESCRIPTION OF THE DRAWINGS

Exemplary embodiments of the present invention will be described in detail based on the following figures, wherein:

FIG. 1 is a schematic view of an image forming apparatus according to a first exemplary embodiment;

FIGS. 2A and 2B are schematic views of an image forming unit according to the first exemplary embodiment, and out of FIGS. 2A and 2B, FIG. 2A illustrates the image forming unit during an image forming process and FIG. 2B illustrates the image forming unit during accumulation removal;

FIGS. 3A and 3B are enlarged views of an image forming surface illustrating a concept of dot patterns of an image, and out of FIGS. 3A and 3B, FIG. 3A illustrates a normal image and FIG. 3B illustrates a defective image where an image deletion occurs;

FIG. 4 illustrates control blocks of an accumulation removal control device according to the first exemplary embodiment, classifying, in accordance with functions, types of control performed when the cleaning blade cleaning mode is performed;

FIG. 5 is a flowchart illustrating a flow of control of an accumulation removal operation on a cleaning blade according to the first exemplary embodiment;

FIGS. 6A and 6B are schematic views of an image forming unit according to a second exemplary embodiment, and out of FIGS. 6A and 6B, FIG. 6A illustrates the image forming unit during the image forming process and FIG. 6B illustrates the image forming unit during the accumulation removal;

FIG. 7 illustrates control blocks of an accumulation removal control device according to the second exemplary embodiment, classifying, in accordance with functions, types of control performed when the cleaning blade cleaning mode is performed;

FIG. 8 is a flowchart illustrating a flow of control of an accumulation removal operation the a cleaning blade according to the second exemplary embodiment;

FIGS. 9A and 9B are schematic views of variations of the image forming units, and out of FIGS. 9A and 9B, FIG. 9A is a variation of the first exemplary embodiment (first variation) and FIG. 9B is a variation of the second exemplary embodiment (second variation).

### DETAILED DESCRIPTION

### First Exemplary Embodiment

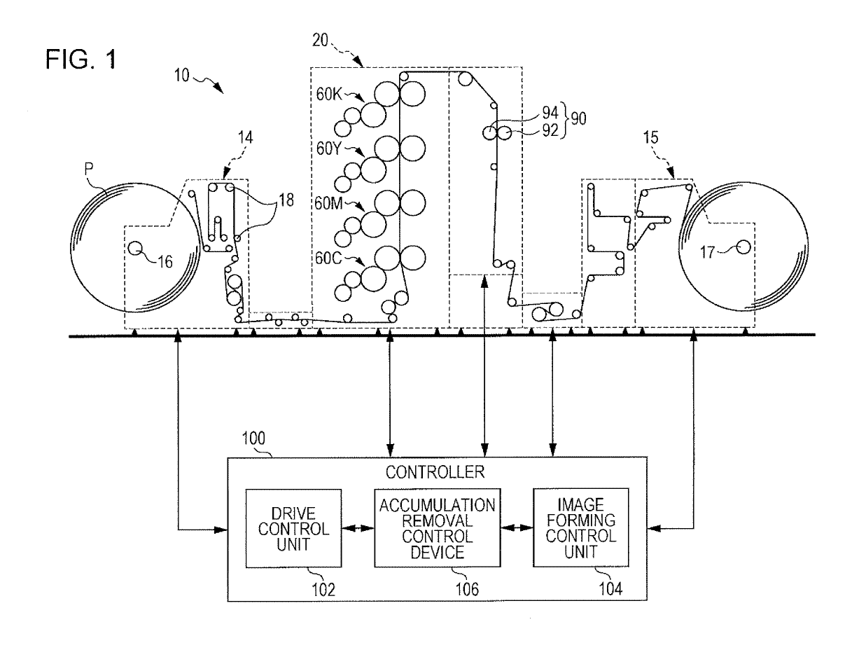

FIG. 1 is a schematic view of an image forming apparatus 10 according to a first exemplary embodiment.

A recording medium P is loaded by being wound one turn on top of another on a sheet feed roller 16 of a sheet feed unit 14 in advance. Typical examples of the recording medium P include sheet materials such as paper and a resin film.

First from an outer most turn of the recording medium P, the recording medium P wound on the sheet feed roller 16 is pulled from the sheet feed roller 16, looped over plural stretch rollers 18, and fed to an image forming section 20. The recording medium P onto which images have been formed by the image forming section 20 is wound on a winding roller 17 of a containing section 15. The winding roller 17 is rotated so as to wind the recording medium P one turn on top of another.

Furthermore, at least one of the stretch rollers 18 is a drive roller, thereby tension applied to the recording medium P between the rollers is adjusted while the recording medium P is wound on the winding roller 17.

The image forming apparatus 10 includes a controller 100. The controller 100 includes a drive control unit 102 and an image forming control unit 104. The drive control unit 102 is for a drive system and controls drive of the drive system (typically including motors) that transports the recording medium P in the sheet feed unit 14, the image forming section 20, and the containing section 15. The image forming control unit 104 obtains image data from the outside, converts the image data into light exposure data, and controls the image forming process in the image forming section 20.

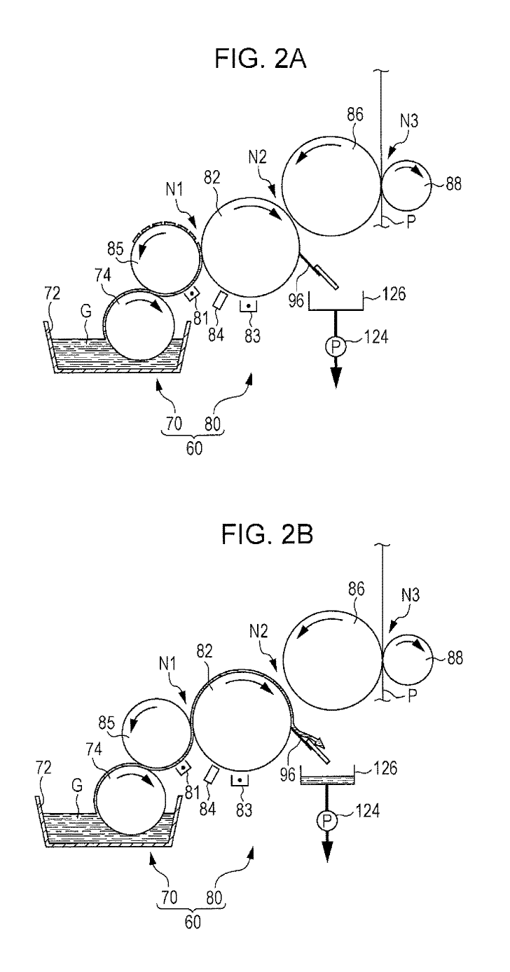

The image forming apparatus 10 according to the first exemplary embodiment transfers and fixes images (toner images) of toner particles contained in liquid developer G (see FIG. 2A) onto the surface of the recording medium P, thereby forming an image on the surface of the recording medium P.

The image forming section 20 forms the image on the surface of the recording medium P by forming the toner images with the liquid developer G, transferring the toner images onto the surface of the recording medium P, and fixing the toner onto the surfaces of the recording medium P. The image forming section 20 includes image forming units 60C, 60M, 60Y, and 60K arranged in the vertical direction (apparatus height direction) of FIG. 1 and drive rollers disposed on the upstream and downstream sides of the image forming units 60C, 60M, 60Y, and 60K.

The rotational speeds of the drive rollers are each independently controlled by the drive control unit 102 of the controller 100. For example, in order to maintain the tension applied to the recording medium P within a predetermined range while the recording medium P is being transported, the transport speed of drive roller on the downstream side is set to be higher than that of the drive roller on the upstream side.

Each of the image forming units 60C, 60M, 60Y, and 60K has the functions of forming a toner image of a corresponding one of colors and transferring the toner image onto the recording medium P being transported. The image forming units 600, 60M, 60Y, and 60K are arranged in this order from the upstream side to the downstream side (from the lower side to the upper side of FIG. 1) in the transport direction of the recording medium P along a transport path of the recording medium P.

Here, suffixes “C”, “M”, “Y”, and “K” respectively indicate cyan, magenta, yellow, and black. Accordingly, the image forming units 60C, 60M, 60Y, and 60K respectively form toner images of C color, M color, Y color, and K color. Furthermore, the image forming units 60C, 60M, 60Y, and 60K have the same or similar structure except for the colors of the toner contained in the liquid developer G used for the respective image forming units 60C, 60M, 60Y, and 60K.

Accordingly, the suffixes C, M, Y, and K are omitted in detailed description of the image forming units 60 with reference to FIG. 2A.

As illustrated in FIG. 2A, each of the image forming units 60 includes a developer supply device 70 and a transfer device 80.

The developer supply device 70 contains the liquid developer G and supplies the liquid developer G to the transfer device 80. The developer supply device 70 includes a container 72 and a supply roller 74. The supply roller 74 is partially submerged in the liquid developer G contained in the container 72.

The container 72 is connected to an external tank (not illustrated) so as to be replenished with the liquid developer G from the external tank where the liquid developer G is stored.

The supply roller 74 lifts the liquid developer G contained in the container 72 while being rotated, thereby supplying the liquid developer G to a developing roller 85 which will be described later. Here, the layer thickness of the liquid developer G to be supplied to the developing roller 85 is adjusted by a blade (not illustrated). The developing roller 85 is employed so that the liquid developer G is charged by a developer charger 81, thereby imparting charge to the liquid developer G.

The transfer device 80 transfers to the recording medium P the toner image formed on a photosensitive drum 82 with the liquid developer G. The photosensitive drum 82 serves as an image holding member and will be described later. The transfer device 80 includes the photosensitive drum 82, a photosensitive drum charger 83, a light exposure device 84, the above-described developing roller 85, a transfer drum 86, and a transfer roller 88.

The photosensitive drum 82 holds a latent image, and the photosensitive drum charger 83 charges the photosensitive drum 82.

The light exposure device 84 forms the latent image on the photosensitive drum 82 having been charged by the charger 83. The developing roller 85 develops the latent image held by the photosensitive drum 82 into the toner image with the liquid developer G supplied from the developer supply device 70.

The developing roller 85, together with the photosensitive drum 82, forms a nip N1. A voltage is applied to the developing roller 85 while the developing roller 85 is being rotated, and an electric field formed in the nip N1 is utilized to develop the latent image held by the photosensitive drum 82 into the toner image.

The transfer drum 86 allows the toner image formed on the photosensitive drum 82 to be transferred through first transfer onto an outer circumferential surface of the transfer drum 86 and to be held on the outer circumferential surface of the transfer drum 86. The transfer drum 86, together with the photosensitive drum 82, forms a nip N2. A voltage is applied to the transfer drum 86 while the transfer drum 86 is being rotated, and an electric field formed in the nip N2 is utilized to transfer through the first transfer the toner image held by the photosensitive drum 82 onto the outer circumferential surface of the transfer drum 86.

The photosensitive drum 82 is provided with a cleaning blade 96. The cleaning blade 96 scrapes off the toner particles not having been transferred through the first transfer in the nip N2.

Surface resistance of the photosensitive drum 82 is reduced by an increase in water generated by adhesion of discharge products, which are generated from the liquid developer G by the photosensitive drum charger 83. This reduction of the surface resistance of the photosensitive drum 82 causes an image defect, that is, a so-called image deletion.

The image deletion defect causes dot patterns that form images to be continuous with one another to such a degree that the roundness of the dot patterns is not able to be measured.

As an example, 5 g/m² of the liquid developer G is taken from the container 72 to form a thin film layer of the liquid developer G on the developing roller 85, charge is imparted by the developer charger 81 to the toner particles, and a so-called solid image is formed on the photosensitive drum 82. The concentration of a solid component of the liquid developer G of the solid image formed on the photosensitive drum 82 is 40% by weight.

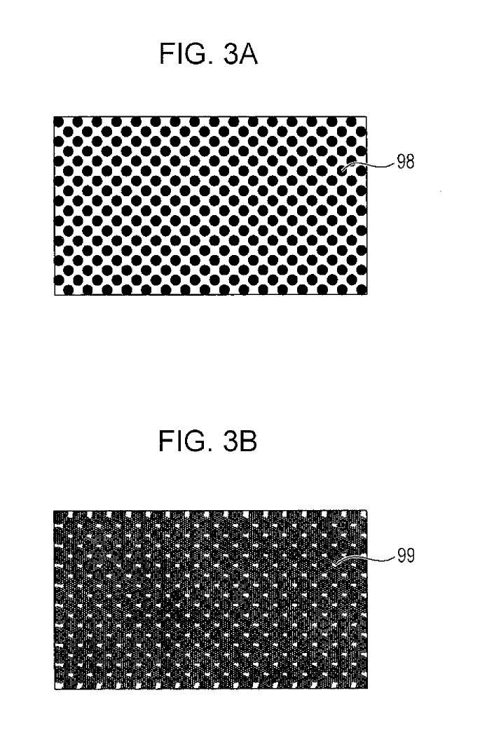

FIG. 3A illustrates an initial stage of an accumulated time period in the image forming process. Image elements 98 formed of dot patterns are independent of one another, and accordingly, the roundness is able to be measured. At this stage, the image deletion defect does not occur.

When the accumulated image forming time period of the solid image exceeds four hours, as illustrated in FIG. 3B, adjacent dot patterns become continuous and boundaries between image elements 99 formed of the dot patterns are difficult to be recognized. Thus, the roundness is not able to be measured, and the image deletion defect occurs.

The cleaning blade 96 effectively removes the discharge products (accumulation) remaining on the photosensitive drum 82 after the first transfer in the nip N2 has been performed. However, when the image deletion occurs, replacement of the cleaning blade 96 is unavoidable in some cases.

In the image forming apparatus 10 according to the first exemplary embodiment, a structure that maintains the function of removing the discharge products (accumulation) from the cleaning blade 96 is provided (described in detail later).

As illustrated in FIG. 2A, the transfer roller 88 transfers through second transfer the toner image held on the outer circumferential surface of the transfer drum 86 onto the recording medium P being transported. The transfer roller 88 is disposed on the opposite side of the transport path of the recording medium P to the transfer drum 86 and forms, together with the transfer drum 86, a nip N3. A voltage is applied to the transfer roller 88 while the transfer roller 88 is being rotated, and an electric field formed in the nip N3 is utilized to transfer through the second transfer the toner image held on the outer circumferential surface of the transfer drum 86 onto the recording medium P.

As illustrated in FIG. 1, a fixing device 90 is provided downstream of the image forming units 60. The fixing device 90 includes a heating roller 92 and a pressure roller 94.

The fixing device 90 applies heat and pressure to the toner images of the multiple colors formed on the surface of the recording medium P by the image forming units 60, thereby fixing the toner images formed by the image forming units 60 onto the surface of the recording medium P. Cleaning of the Cleaning Blade 96 (Accumulation Removal)

Here, as has been described, the cleaning blade 96 is disposed at the circumferential surface of the photosensitive drum 82.

As the cleaning blade 96 continues to scrape off the discharge products remaining on the photosensitive drum 82, the discharge products are gradually accumulated. This degrades the scraping function, which is the original function of the cleaning blade 96. In addition, the accumulated discharge products (accumulation) may cause the image deletion (image defect illustrated in FIG. 3B).

In order to address this, according to the first exemplary embodiment, a cleaning blade cleaning mode in which the cleaning blade 96 is cleaned is provided. The controller 100 includes an accumulation removal control device 106 in addition to the drive control unit 102 and the image forming control unit 104 having been described. The accumulation removal control device 106 controls operation of an accumulation removal function at appropriate timing, for example, every time a predetermined amount of processing has been performed. The accumulation removal control device 106 performs the cleaning blade cleaning mode.

Basically, according to the first exemplary embodiment, some of the elements of the apparatus that are already included in the image forming apparatus 10 are used for devices to perform the cleaning blade cleaning mode. This may suppress an increase in the number of components.

First, it is required that the material that removes the accumulation accumulated on the cleaning blade 96 be a liquid and have a so-called abrasive property. Thus, the liquid developer G containing the toner particles is usable. In other words, the toner particles have the abrasive property.

When using the liquid developer G for accumulation removal for the cleaning blade 96, in order to maintain a predetermined flowability, the concentration of the toner particle component (solid component) is set to be lower than that of the toner particle component of the liquid developer G fed from the developing roller 85 to the photosensitive drum 82 in a normal image forming process.

More specifically, according to the first exemplary embodiment, the toner particles (having a volume mean particle diameter of 2 μm) containing polyester-based resin as a principal component of binding resin are dispersed in a silicone oil (KF96L-10CS made by Shin-Etsu Chemical Co., Ltd) so as to obtain a low concentration liquid developer the solid component concentration of which is 25% by weight. When there is no problem with the image quality in the image forming process, this low concentration liquid developer is used as the liquid developer G. Although the silicone oil is non-volatile, a volatile material may instead be used.

In order to perform the accumulation removal for the cleaning blade 96, charging of the developing roller 85 by the developer charger 81 and charging of the photosensitive drum 82 by the photosensitive drum charger 83 are not performed, and the liquid developer G is supplied to the cleaning blade 96 while the concentration (flowability) of the liquid developer G in the container 72 is maintained.

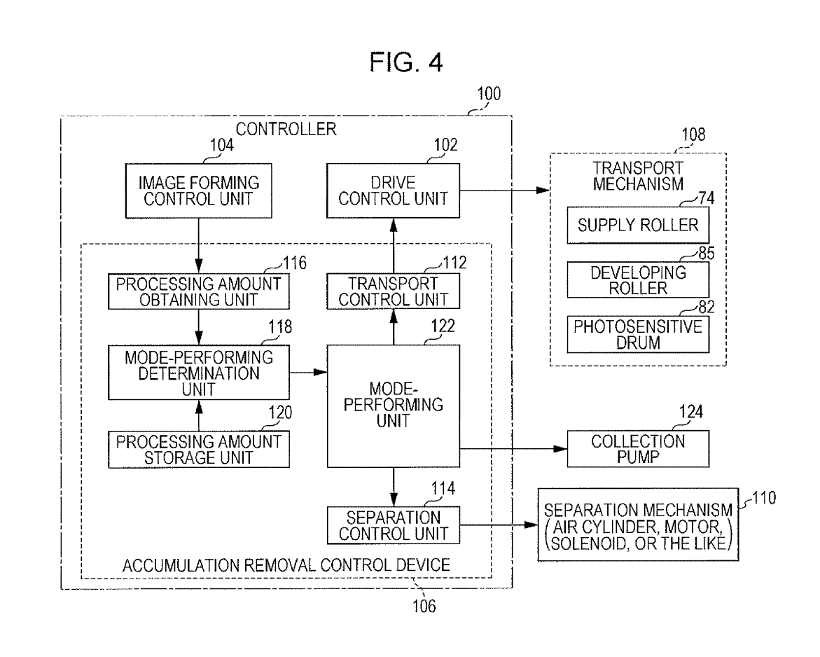

The supply roller 74, the developing roller 85, and the photosensitive drum 82 are used for a transport mechanism 108 (see FIG. 4) that transports the liquid developer G from the container 72 to the cleaning blade 96.

Furthermore, according to the first exemplary embodiment, a separation mechanism 110 (see FIG. 4) is provided so as to separate the photosensitive drum 82 and the transfer drum 86 from each other. The separation mechanism 110 uses a drive source such as, for example, an air cylinder, a motor, or a solenoid so as to physically separate the photosensitive drum 82 and the transfer drum 86 from each other.

FIG. 4 illustrates control blocks of the accumulation removal control device 106, classifying, in accordance with functions, types of control performed when the cleaning blade cleaning mode is performed in the controller 100 according to the first exemplary embodiment. It is noted that the blocks of FIG. 4 are classified in accordance with the functions and do not limit a hardware configuration.

As illustrated in FIG. 4, the accumulation removal control device 106 includes a transport control unit 112 and a separation control unit 114. The transport control unit 112 causes the supply roller 74, the developing roller 85, and the photosensitive drum 82 to operate as the transport mechanism 108. The separation control unit 114 causes the separation mechanism 110 to operate.

The transport control unit 112 controls operations of the supply roller 74, the developing roller 85, and the photosensitive drum 82 through the drive control unit 102.

The accumulation removal control device 106 also includes a processing amount obtaining unit 116. The processing amount obtaining unit 116 is connected to the image forming control unit 104 and obtains a processing amount of the image forming from this image forming control unit 104.

The processing amount obtaining unit 116 is connected to a mode-performing determination unit 118. A processing amount storage unit 120 is connected to the mode-performing determination unit 118. The mode-performing determination unit 118 determines whether or not to perform the cleaning blade cleaning mode depending on whether or not the processing amount obtained by the processing amount obtaining unit 116 has reached a predetermined processing amount stored in the processing amount storage unit 120.

The mode-performing determination unit 118 is connected to a mode-performing unit 122 and outputs a mode-performing instruction signal to the mode-performing unit 122 in order to perform the cleaning blade cleaning mode.

The mode-performing unit 122 is connected to the transport control unit 112 and the separation control unit 114 and outputs mode-performing instructions to the transport control unit 112 and the separation control unit 114 in accordance with predetermined timing.

Furthermore, a collection pump 124 is connected to the mode-performing unit 122. The collection pump 124 collects the liquid developer G stored in the tank 126. This liquid developer G stored in the tank 126 has been supplied to the photosensitive drum 82 for cleaning the cleaning blade 96 and scraped off by the cleaning blade 96.

Operation according to the first exemplary embodiment is described below.

### A Flow of the Image Forming

First, a flow of processing for the image forming with the image forming apparatus 10 is described.

Upon reception of image data, the controller 100 converts the image data into light exposure data of each of the colors and passes the light exposure data to the light exposure device 84 of a corresponding one of the image forming units 60.

Next, in accordance with an image forming performing instruction, the photosensitive drum 82C is charged by the charger 83C and this charged photosensitive drum 82 is exposed to light from the light exposure device 84C so as to form a latent image for C color on the photosensitive drum 82C in the image forming units 60C. This latent image for C color is developed into a toner image of C color by the developing roller 85C to which the liquid developer G for C color is supplied from the developer supply device 70C.

Next, the toner image of C color reaches the nip N2 due to rotation of the photosensitive drum 82C and transferred through the first transfer onto the transfer drum 86C. Furthermore, the toner image of C color having been transferred onto the transfer drum 86C reaches the nip N3 due to rotation of the transfer drum 86C. The toner image of C color having reached the nip N3 is transferred through the second transfer by the transfer roller 88C onto the surface of the recording medium P being transported.

Likewise, in the image forming units 60M, 60Y, and 60K of the image forming units 60, toner images of M color, Y color, and K color are sequentially transferred through the second transfer from the transfer drum 86M, 86Y, and 86K onto the surface of the recording medium P so as to be superposed on the toner image of C color having been transferred through the second transfer onto the surface of the recording medium P.

Next, the recording medium P on the surface of which the toner images of the colors have been formed by the image forming units 60 reaches the fixing device 90. The fixing device 90 applies heat and pressure to the toner images of the colors on the surface of the recording medium P so as to fix the toner images onto the surface of the recording medium P.

### Accumulation Removal for the Cleaning Blade

As the cleaning blade 96 that faces the surface of the photosensitive drum 82 continues to scrape off the discharge products remaining on the photosensitive drum 82, the discharge products are gradually accumulated.

This degrades the scraping function, which is the original function of the cleaning blade 96. In addition, the accumulated discharge products may cause the image deletion as illustrated in FIG. 3B. Thus, an image defect may occur.

In order to address this, according to the first exemplary embodiment, the accumulation removal control device 106 is provided in the controller 100 so as to perform a cleaning blade cleaning mode in which the cleaning blade 96 is cleaned.

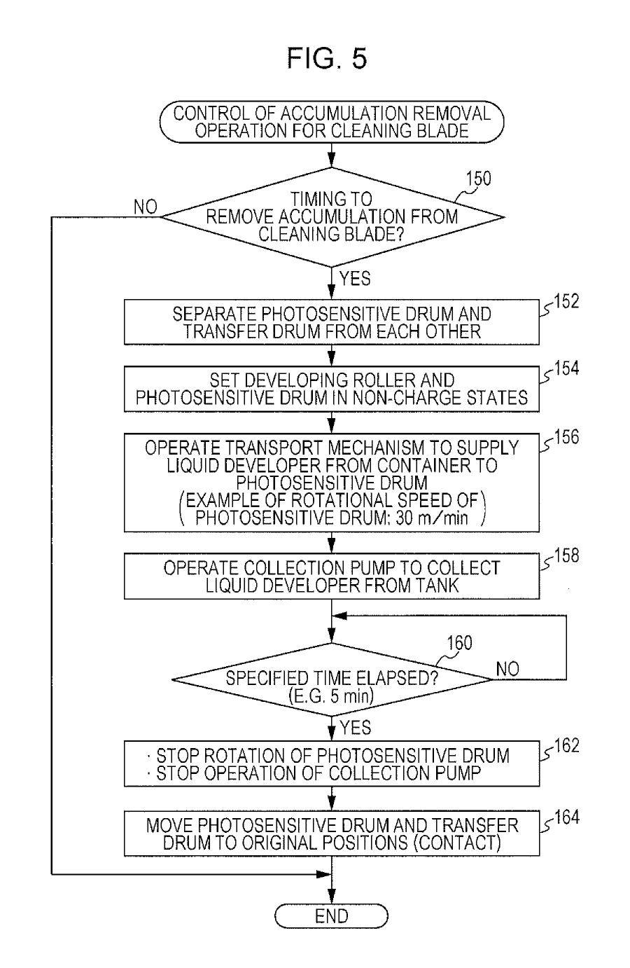

FIG. 5 is a flowchart of control illustrating a flow of the cleaning blade cleaning mode in accordance with control performed by the accumulation removal control device 106 according to the first exemplary embodiment.

In step 150, it is determined that if accumulation removal timing for the cleaning blade 96 arrives or not. In this determination, every time the image forming processing amount obtained from the image forming control unit 104 reaches a predetermined processing amount, it is determined that the accumulation removal timing for the cleaning blade 96 arrives.

When the determination in step 150 is negative, this routine ends.

When the determination in step 150 is positive, processing moves to step 152 in which the photosensitive drum 82 and the transfer drum 86 are separated from each other. Next, the processing moves to step 154 in which the developing roller 85 and the photosensitive drum 82 are set in non-charge states.

In the next step 156, the supply roller 74, the developing roller 85, and the photosensitive drum 82 as parts of the transport mechanism 108 supply the liquid developer G from the container 72 to the photosensitive drum 82. The rotational speed of the photosensitive drum 82 at this time is preferably set to be, for example, about 30 m/min.

Since the photosensitive drum 82 and the transfer drum 86 are kept separated from each other, most of the liquid developer G supplied to the photosensitive drum 82 reaches the cleaning blade 96, is scraped off by the cleaning blade 96, and is contained in the tank 126.

The liquid developer G contained in the tank 126 is collected by operating the collection pump 124 (step 158).

At this time, the toner particles contained in the liquid developer G function as a so-called abrasive agent, thereby removing the accumulation from the cleaning blade 96. This restores the original function to the cleaning blade 96.

In other words, an image defect due to the image deletion caused by the accumulation on the cleaning blade 96 may be suppressed.

In the next step 160, it is determined that if a specified time period has elapsed or not. During this specified time period, the liquid developer G is supplied to the cleaning blade 96. The specified time period is able to be experimentally or empirically determined. The specified time period is set to five minutes according to the first exemplary embodiment.

If positive determination is made in step 160, that is, it is determined that the specified time period (five minutes here) has elapsed from the start of supplying the liquid developer G, the processing moves to step 162 in which the rotation of the photosensitive drum 82 and the operation of the collection pump 124 are stopped.

In the next step 164, the photosensitive drum 82 and the transfer drum 86 are moved to the original positions (a contact state). Thus, this routine ends.

### Experimental Examples

After a continuous 60-minute image forming process is completed, the photosensitive drum 82 is driven at a circumferential speed of 30 m/min while the transfer drum 86 is kept separated from the photosensitive drum 82 and the cleaning blade 96 is in contact with the photosensitive drum 82.

An operation in which the liquid developer G the solid component concentration of which is 25% by weight is supplied to the cleaning blade 96 at a supply speed of 100 g/min is continuously performed for five minutes. Then the operation is stopped.

When the image forming process and the cleaning operation described above are repeatedly performed, the image deletion does not occur and the image forming process is maintained in a good state even after the accumulated time period of the image forming process exceeds 60 hours.

Next, the same experiment as the above-described experiment is performed while the solid component concentration of the liquid developer G supplied in an accumulation removal operation for the cleaning blade 96 is set to 0% by weight, 5% by weight, and 10% by weight.

When the solid component concentration is 0% by weight and 5% by weight, the image deletion starts to occur after the accumulated time period of the image forming process exceeds four hours. This results in a poor image forming process.

When solid component concentration is set to 10% by weight, the image deletion does not occur and the image forming process is maintained in a good state even after the accumulated time period of the image forming process exceeds 60 hours.

That is, according to the results of the above-described experiments, it is found that, with the liquid developer G the solid component concentration of which is 10% or more by weight, the image deletion caused by the accumulation on the cleaning blade 96 is able to be suppressed.

It is noted that, when the toner particles of a volume mean particle diameter other than 2 μm is used, or when particles (for example, abrasive particles or the like) other than the toner particles are used, a threshold value used to determine whether or not the solid component concentration is good varies.

### A Second Exemplary Embodiment

A second exemplary embodiment is described below. In the second exemplary embodiment, elements having the same structures as those of the first exemplary embodiment are denoted by the same reference numerals, thereby omitting the description of the structures.

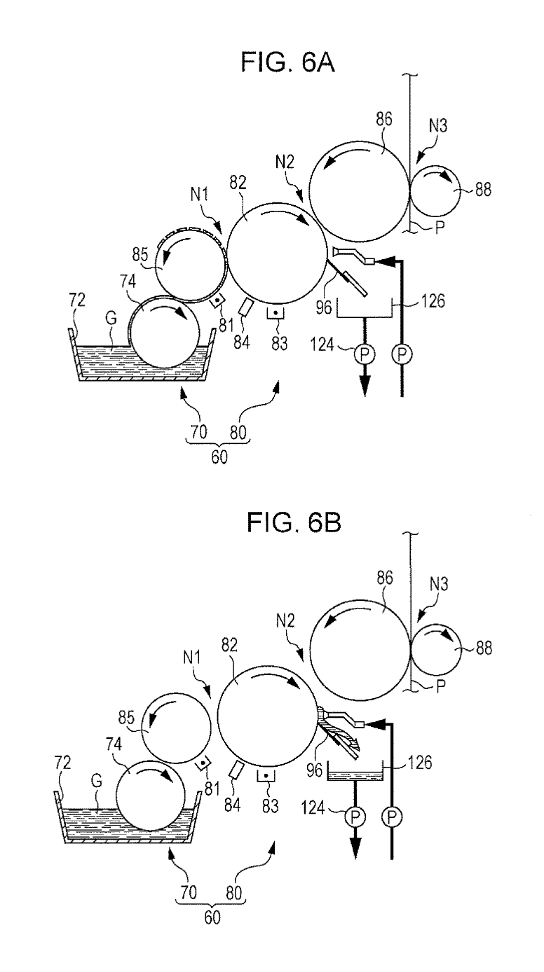

As illustrated in FIGS. 6A and 6B, the second exemplary embodiment is characterized in that the liquid developer G is directly supplied to the photosensitive drum 82 by a supply pump 125.

In other words, whereas the transport mechanism 108 according to the first exemplary embodiment includes the supply roller 74, the developing roller 85, and the photosensitive drum 82 that are already included in the image forming apparatus 10, a transport mechanism 108A according to the second exemplary embodiment includes the supply pump 125.

For this reason, according to the second exemplary embodiment, when the accumulation removal operation is performed for the cleaning blade 96, as illustrated in FIG. 6B, the transfer drum 86 and the developing roller 85 are removed from the photosensitive drum 82.

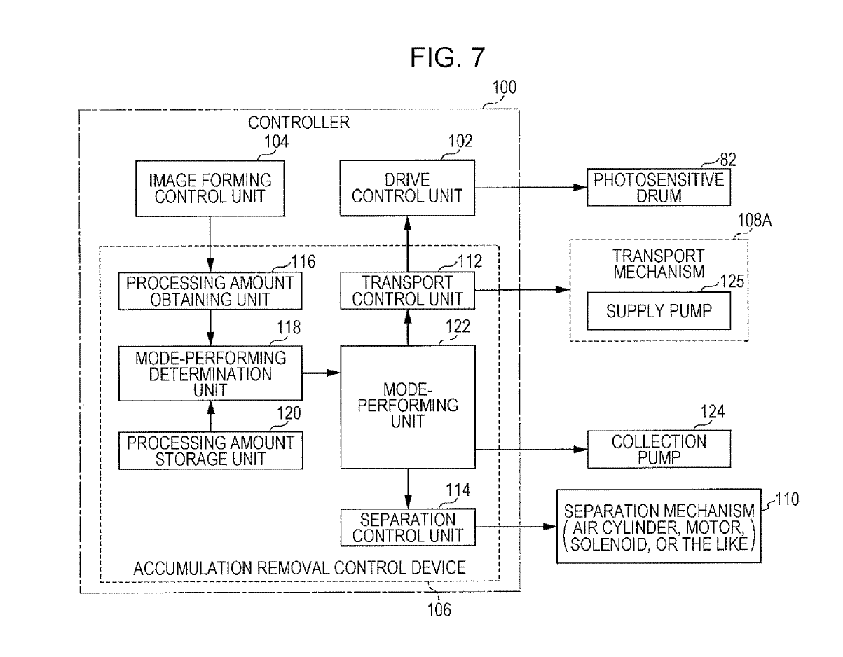

FIG. 7 illustrates control blocks of the accumulation removal control device 106, classifying, in accordance with functions, types of control performed when the cleaning blade cleaning mode is performed in the controller 100 according to the second exemplary embodiment. It is noted that the blocks of FIG. 7 are classified in accordance with the functions and do not limit a hardware configuration.

As illustrated in FIG. 7, the accumulation removal control device 106 includes the transport control unit 112 and the separation control unit 114. The transport control unit 112 causes the supply pump 125 to operate as the transport mechanism 108A. The separation control unit 114 causes the separation mechanism 110 to operate.

The transport control unit 112 controls the operations of the photosensitive drum 82 through the drive control unit 102.

The accumulation removal control device 106 also includes the processing amount obtaining unit 116. The processing amount obtaining unit 116 is connected to the image forming control unit 104 and obtains the image forming processing amount from this image forming control unit 104.

The processing amount obtaining unit 116 is connected to the mode-performing determination unit 118. The processing amount storage unit 120 is connected to the mode-performing determination unit 118. The mode-performing determination unit 118 determines whether or not to perform the cleaning blade cleaning mode depending on whether or not the processing amount obtained by the processing amount obtaining unit 116 has reached the predetermined processing amount stored in the processing amount storage unit 120.

The mode-performing determination unit 118 is connected to the mode-performing unit 122 and outputs the mode-performing instruction signal to the mode-performing unit 122 in order to perform the cleaning blade cleaning mode.

The mode-performing unit 122 is connected to the transport control unit 112 and the separation control unit 114 and outputs the mode-performing instructions to the transport control unit 112 and the separation control unit 114 in accordance with the predetermined timing.

Furthermore, the collection pump 124 is connected to the mode-performing unit 122. The collection pump 124 collects the liquid developer G stored in the tank 126. This liquid developer G stored in the tank 126 has been supplied to the photosensitive drum 82 for cleaning the cleaning blade 96 and scraped off by the cleaning blade 96.

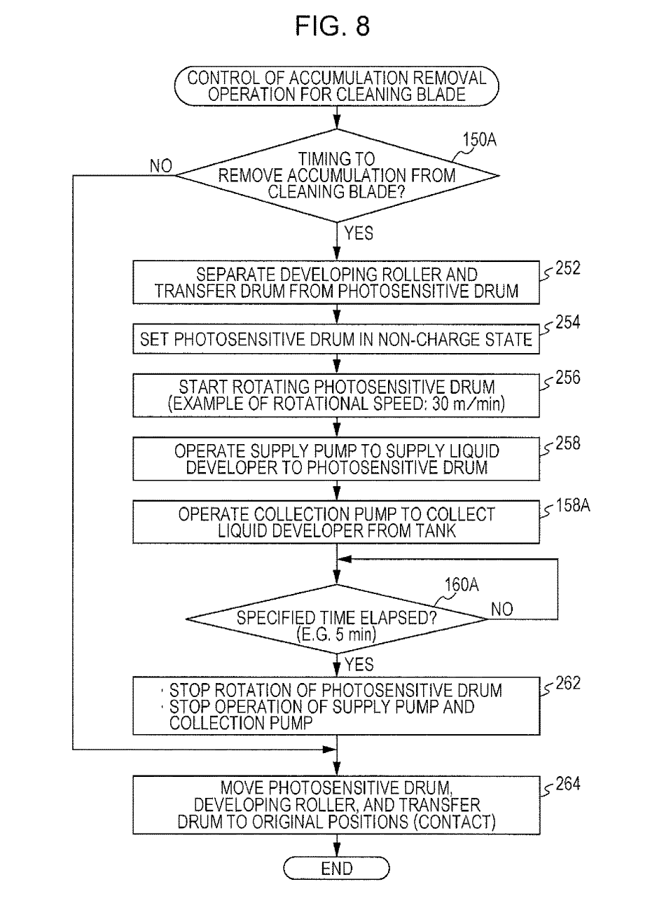

FIG. 8 is a flowchart of control illustrating a flow of the cleaning blade cleaning mode in accordance with control performed by the accumulation removal control device 106 according to the second exemplary embodiment. The same steps as those of the operating control according to the first exemplary embodiment illustrated in FIG. 5 are each denoted by the same numeral with a sign “A” added to the end of the numeral.

In step 150A, it is determined that if the accumulation removal timing for the cleaning blade 96 arrives or not. In this determination, every time the image forming processing amount obtained from the image forming control unit 104 reaches the predetermined processing amount, it is determined that the accumulation removal timing for the cleaning blade 96 arrives.

When the determination in step 150A is negative, this routine ends.

When the determination in step 150A is positive, processing moves to step 252 in which the developing roller 85 and the transfer drum 86 are separated from the photosensitive drum 82. Next, the processing moves to step 254 in which the photosensitive drum 82 is set in a non-charge state.

In the next step 256, the rotation of the photosensitive drum 82 is started (the rotational speed of the photosensitive drum 82 is preferably set to be, for example, about 30 m/min).

In the next step 258, the supply pump 125 functioning as the transport mechanism 108A is operated so as to directly supply the liquid developer G to the photosensitive drum 82.

As a result of this, since the photosensitive drum 82 is kept separated from the developing roller 85 and the transfer drum 86, most of the liquid developer G supplied to the photosensitive drum 82 reaches the cleaning blade 96, is scraped off by the cleaning blade 96, and is contained in the tank 126.

At this time, the toner particles contained in the liquid developer G function as a so-called abrasive agent, thereby removing the accumulation from the cleaning blade 96. This restores the original function to the cleaning blade 96.

In other words, an image defect due to the image, deletion caused by the accumulation on the cleaning blade 96 may be suppressed.

The liquid developer G contained in the tank 126 is collected by operating the collection pump 124 (step 158A).

In the next step 160A, it is determined that if a specified time period has elapsed or not. During this specified time period, the liquid developer G is supplied to the cleaning blade 96. The specified time period is able to be experimentally or empirically determined. The specified time period is set to five minutes according to the second exemplary embodiment.

If positive determination is made in step 160A, that is, it is determined that the specified time period (five minutes here) has elapsed from the start of supplying the liquid developer G, the processing moves to step 262 in which the rotation of the photosensitive drum 82 is stopped and the operations of the supply pump 125 and the collection pump 124 are stopped.

In the next step 264, the photosensitive drum 82, the developing roller 85, and the transfer drum 86 are moved to the original positions (a contact state). Thus, this routine ends.

### Variations

Although the image forming apparatus 10 is exemplified by the structure in which, as illustrated in FIG. 1, the recording medium P is transported in the up-down direction (for example, vertical direction) in the image forming section 20 according to the first exemplary embodiment and the second exemplary embodiment, the recording medium P is not necessarily transported in the up-down direction.

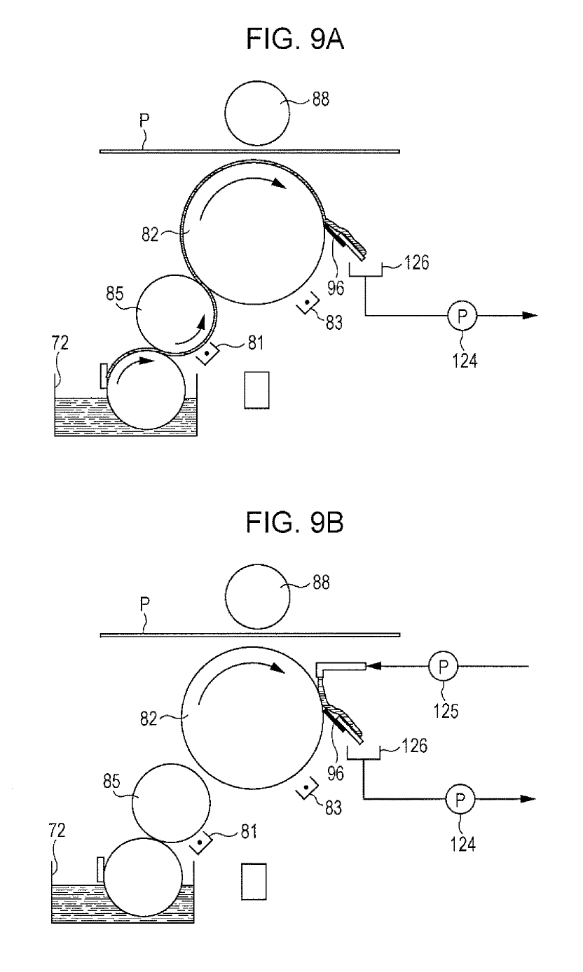

For example, as illustrated in FIGS. 9A and 9B, the image forming unit may have a structure in which the recording medium P is transported in the transverse direction (for example, horizontal direction) and the toner image on the photosensitive drum 82 is directly transferred onto the recording medium P.

Here, FIG. 9A is a variation of the first exemplary embodiment (first variation) in which the supply roller 74, the developing roller 85, and the photosensitive drum 82 function as the transport mechanism 108 of FIG. 4.

FIG. 9B is a variation of the second exemplary embodiment (second variation) in which the supply pump 125 functions as the transport mechanism 108A of FIG. 7.

Furthermore, according to the exemplary embodiments, the toner particles contained in the liquid developer G are used as the so-called abrasive agent that removes the accumulation. However, according to, for example, the second exemplary embodiment, the liquid developer G is not necessarily used as the abrasive agent because the liquid developer G is able to be supplied from other than the container 72 by the supply pump 125.

Examples of an alternative to the liquid developer G that are usable and have an abrasive function include an insulating liquid such as a liquid paraffin oil or a silicone oil containing silicone resin particles (volume mean particle diameter is 4 μm; indefinite shape) or cross-linked polymethyl methacrylate resin particles (volume mean particle diameter is 8 μm; spherical shape) dispersed therein. The insulating liquid may be a carrier liquid of the liquid developer G.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An accumulation removal device comprising:
a cleaning blade that is disposed so as to be in contact with a surface of an image holding member and that cleans the surface of the image holding member after an image forming process has been performed;
a fluid supply device that supplies a fluid which contains solid particles to a position where the cleaning blade is disposed; and
an instruction device that issues an instruction to cause the fluid supply device to supply the fluid at predetermined timing.

2. The accumulation removal device according to claim 1,
wherein, when the fluid is supplied by the fluid supply device, a member which is other than the cleaning blade and which causes a path to which the fluid is able to branch is separated from the fluid supply device.

3. The accumulation removal device according to claim 1,
wherein the fluid is a liquid developer used for the image forming process.

4. The accumulation removal device according to claim 2,
wherein the fluid is a liquid developer used for the image forming process.

5. The accumulation removal device according to claim 3,
wherein the liquid developer used as the fluid is a low concentration liquid developer prepared so as to contain developing particles as the solid particles a concentration of which is lower than a concentration of the developing particles contained in the liquid developer used for the image forming process.

6. The accumulation removal device according to claim 4,
wherein the liquid developer used as the fluid is a low concentration liquid developer prepared so as to contain developing particles as the solid particles a concentration of which is lower than a concentration of the developing particles contained in the liquid developer used for the image forming process.

7. An image forming apparatus comprising:
an image forming section that includes
an image holding member having a surface,
a developing member, and
a transfer member disposed so as to be in contact with the image holding member, and
that forms an image by forming, in accordance with image information, an electrostatic latent image on the image holding member the surface of which has been charged in advance; developing the electrostatic latent image with a liquid developer containing developing particles by using the developing member; and transferring the developed image to a recording medium by using the transfer member;
a cleaning blade that is disposed so as to be in contact with the surface of the image holding member and that removes the developing particles remaining on the surface of the image holding member after the developed image has been transferred;
a fluid supply device that supplies a fluid which contains solid particles to a position where the cleaning blade is disposed; and
an instruction device that issues an instruction to cause the fluid supply device to supply the fluid at predetermined timing.

8. The image forming apparatus according to claim 7,
wherein the fluid is the liquid developer, and the developing member and the image holding member are driven as the fluid supply device.

9. The image forming apparatus according to claim 8,
wherein, when the fluid is supplied by the fluid supply device, the transfer member is separated from the image holding member.

10. The image forming apparatus according to claim 7,
wherein the fluid is the liquid developer, and the fluid supply device supplies the liquid developer through a different path from a path through which the liquid developer is supplied for an image forming process performed by the image forming section.

11. The image forming apparatus according to claim 8,
wherein the liquid developer used as the fluid is a low concentration liquid developer prepared so as to contain the developing particles as the solid particles a concentration of which is lower than a concentration of the developing particles contained in the liquid developer used for an image forming process performed by the image forming section.

12. The image forming apparatus according to claim 9,
wherein the liquid developer used as the fluid is a low concentration liquid developer prepared so as to contain the developing particles as the solid particles a concentration of which is lower than a concentration of the developing particles contained in the liquid developer used for an image forming process performed by the image forming section.

13. The image forming apparatus according to claim 10,
wherein the liquid developer used as the fluid is a low concentration liquid developer prepared so as to contain the developing particles as the solid particles a concentration of which is lower than a concentration of the developing particles contained in the liquid developer used for the image forming process performed by the image forming section.

14. The image forming apparatus according to claim 11,
wherein the low concentration liquid developer is prepared by setting at least the image holding member in a non-charge state.

15. The image forming apparatus according to claim 12,
wherein the low concentration liquid developer is prepared by setting at least the image holding member in a non-charge state.

16. The image forming apparatus according to claim 13,
wherein the low concentration liquid developer is prepared by setting at least the image holding member in a non-charge state.
